(19) United States
(12) Patent Application Publication
(10) Pub. No.: US 2005/0164905 A1
(43) Pub. Date: Jul. 28, 2005

(54) Aqueous laundry detergent compositions having improved softening properties and improved aesthetics

(76) Inventors: Nalini Chawla, Mason, OH (US); Abdennaceur Fredj, Loveland, OH (US); Gregory Leo Jervier, Cincinnati, OH (US); Gary Gerard Staud, Cincinnati, OH (US); Ronald Allen Swift II, West Chester, OH (US); Daniel Jerome White JR., West Chester, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/036,716

(22) Filed: Jan. 14, 2005

Related U.S. Application Data
(60) Provisional application No. 60/537,127, filed on Jan. 16, 2004.

(51) Int. Cl. C11D 3/00

(52) U.S. Cl. 510/516

(57) ABSTRACT

Aqueous heavy duty liquid laundry detergent compositions useful for laundering fabrics and providing cleaning and softening benefits. Such detergent compositions contain at least 5%, by weight of the composition, of a surfactant component; from about 0.1% to about 10% of a quaternary ammonium fabric-softening agent having the formula 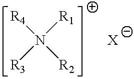
wherein R₁ and R₂ are individually selected from the group consisting of C₁-C₄ alkyl, C₁-C₄ hydroxy alkyl, benzyl, and —(C₂H₄O)ₓH where x has a value from about 2 to about 5; X is an anion; and (1) R₃ and R₄ are each a C₈-C₁₄ alkyl or (2) R₃ is a C₈-C₂₂ alkyl and R₄ is selected from the group consisting of C₁-C₁₀ alkyl, C₁-C₁₀ hydroxy alkyl, benzyl, and —(C₂H₄O)ₓH where x has a value from about 2 to about 5; and such compositions contain less than 10 ppm of trimethylamine and dimethylamine impurities.

### CROSS REFERENCE TO RELATED APPLICATION

This Application claims the benefit of U.S. Provisional Application Ser. No. 60/537,127, filed Jan. 16, 2004.

### TECHNICAL FIELD

The present invention relates to stable, aqueous heavy duty liquid laundry detergent compositions which provide exceptional cleaning as well as fabric softening and anti-static benefits. The detergent compositions herein may be isotropic and contain an anionic surfactant component and a quaternary ammonium fabric-softening agent. The anionic surfactant component contains alkyl polyethoxylate sulfates and a limited amount of alkyl benzene sulfonates.

### BACKGROUND OF THE INVENTION

Numerous aqueous liquid laundry detergent products are commercially available for the laundering of textiles (e.g. bedding, linens, and/or clothing), including those commonly referred to as “heavy duty liquid” formulations. These products have traditionally focused on stain-removal and cleaning benefits and could be used in laundry washing machines and/or hand-washing applications. These products generally provide little or no textile softening and/or static control benefits. Although such softening and static control benefits are certainly very desirable to consumers, traditionally it was found to be difficult to stably include such benefits in conjunction with a cleaning product. Therefore, traditionally, consumers were encouraged to use a separate product, such as a liquid product introduced later in the washing process, preferably during the rinsing cycle either by dispensers (e.g. Downy® Ball or built-in machine dispensers) or by manual addition by the consumer; or such as solid products added, along with the textiles, into the laundry dryer (e.g. Snuggle® or Bounce® dryer sheets) and deposited on the textiles as they are dried. Those seeking to combine both cleaning and softening benefits in a single liquid laundry detergent product found difficulties in doing so due to the inherent juxtaposition between the removal of material from a textile surface necessary for cleaning versus the deposition of material onto the same surface commonly required for softening. Therefore, attempts to combine both cleaning and softening benefits in a single product typically required compromises to be made in the formulation between cleaning and softening performance.

Cationic surfactants, including quaternary ammonium surfactants, have long been recognized as useful additives in detergent compositions for providing static control benefits. However, attempts to formulate aqueous heavy duty liquid laundry detergent compositions containing anionic surfactants along with quaternary ammonium fabric softening agents like lauryl trimethyl ammonium chloride (in order to provide softening through the washing cycle along with static control benefits) have resulted in poor physical product characteristics including phase split or other instability and/or have resulted in poor fabric cleaning performance.

More recently, developments in this area provided for a substantially clear, isotropic, aqueous heavy duty liquid laundry detergent composition provided as a single product, that provides cleaning along with softening and anti-static benefits through the wash. U.S. Pat. No. 5,466,394 discloses a composition purporting to exhibit such properties. The U.S. '394 patent discloses that by limiting the level of alkyl benzene sulfonates in aqueous detergent compositions containing alkyl polyethoxylated sulfates, unsightly precipitates are prevented or inhibited from forming in the detergent product and superior performance (cleaning, softening, and antistatic benefits) are promoted. Such compositions are substantially clear.

However, it has now been discovered that formulations which are marketed for both cleaning and softening benefits have particular appeal to the consumer when they have certain aesthetics. Surprisingly, it has been discovered that consumers expect a cloudy or hazy appearance to a liquid laundry detergent having both cleaning and softening benefits and consequently are skeptical and/or confused when presented with a clear laundry composition purporting to offer such dual benefits. Furthermore, it has been discovered that a selected range of opacity is particularly preferred for such compositions. Therefore, earlier stable substantially clear formulations which successfully combined both cleaning and softening benefits in a stable product have now been found to be unsatisfactory from an aesthetics standpoint.

### SUMMARY OF THE INVENTION

The present invention encompasses aqueous, heavy duty liquid laundry detergent composition containing:
a) at least 5%, by weight of the composition, of a surfactant component;
b) from about 0.1% to about 10% of a quaternary ammonium fabric-softening agent having the formula 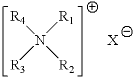
   wherein R₁ and R₂ are individually selected from the group consisting of C₁-C₄ alkyl, C₁-C₄ hydroxy alkyl, benzyl, and —(C₂H₄O)ₓH where x has a value from about 2 to about 5; X is an anion; and (1) R₃ and R₄ are each a C₈-C₁₄ alkyl or (2) R₃ is a C₈-C₂₂ alkyl and R₄ is selected from the group consisting of C₁-C₁₀ alkyl, C₁-C₁₀ hydroxy alkyl, benzyl, and —(C₂H₄O)ₓH where x has a value from about 2 to about 5;
wherein the quaternary ammonium fabric-softening agent comprises less than 10 ppm of trimethylamine and dimethylamine impurities.

These and other features, aspects, and advantages of the present invention will become evident to those skilled in the art from a reading of the present disclosure.

### DETAILED DESCRIPTION OF THE INVENTION

The liquid laundry detergent compositions herein contain a surfactant component and a quaternary ammonium fabric-softening agent a quaternary ammonium fabric-softening agent. Such compositions may contain an opacifier and a relatively large amount of an aqueous liquid carrier. Each of these components as well as optional ingredients for such compositions and methods of preparing and using such compositions are described in detail as follows.

All measurements referenced herein are at room temperature (about 21.1° C.) and at atmospheric pressure, unless otherwise indicated.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages, parts and ratios are based upon the total weight of the liquid laundry detergent compositions of the present invention, unless otherwise specified. All such weights as they pertain to listed ingredients are based on the active level and, therefore, do not include carriers or by-products that may be included in commercially available materials, unless otherwise specified.

All documents cited are, in relevant part, incorporated herein by reference; the citation of any document is not to be construed as an admission that it is prior art with respect to the present invention.

Heavy duty liquid laundry detergents containing anionic surfactants and quaternary ammonium fabric-softening agents of the formula: 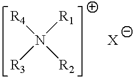
which contain about 5% to 40% of alkyl polyethoxylate sulfates and no more than about 5% of alkyl benzene sulfonates are known to provide substantially clear, isotropic cleaning compositions with both cleaning and softening benefits.

Prior efforts in heavy duty liquids containing cationic softening agents were focused on the formulation of stable, substantially clear formulations. However, it has been discovered that such clear compositions are often undesirable to consumers from an aesthetics point of view for use as laundry detergent products which contain softening and/or anti-static benefits. Although such compositions are aesthetically preferred for strict cleaning detergent compositions, it has surprisingly been found that when presenting a detergent composition purporting to provide both cleaning and softening benefits, to the consumer, such clear aesthetics are not preferred. However, it is also not preferred to return to the older, more opaque formulations that were opaque due to instabilities in the formulation.

Without being limited by theory, it is believed that the consumer-preference of the present invention compositions is due to a consumer expectation that when a liquid laundry detergent, typically having a translucent appearance purports to include benefits that are typically associated with a milky fabric softening product, consumers expect such a combination to appear hazy or slightly milky. This aesthetics expectation cannot be met by the prior art which teaches substantially clear compositions as preferred aesthetically to compositions that contain cloudy, or unclear compositions that contained precipitates and/or instable phases (e.g., separate during storage). It has now surprisingly been found that in order to successfully convince the consumer that a formulation contains both cleaning and softening benefits, a transmittance of from about 15% to about 0.1% may be required.

The heavy duty liquid laundry detergent compositions herein contain a surfactant component, a quaternary ammonium fabric-softening agent, an opacifying agent, and an aqueous liquid carrier. These components are outlined in more detail below.

Surfactant Component

The detergent compositions herein include a surfactant component. The compositions herein include at least 5% of a surfactant component.

In one embodiment, the surfactant component herein includes from about 5% to about 40%, alternatively from about 10% to about 20%, by weight of the detergent composition, of an anionic surfactant component. The anionic surfactant component contains alkyl polyethoxylate sulfates, and may contain other non-soap anionic surfactants, or mixtures thereof. The anionic surfactant component should not contain more than about 6% of alkyl benzene sulfonates. Other laundry detergent surfactants may also be included in the surfactant component.

Generally speaking, anionic surfactants useful herein are disclosed in U.S. Pat. No. 4,285,841, Barratet al., issued Aug. 25, 1981, and in U.S. Pat. No. 3,919,678, Laughlin, et al., issued Dec. 30, 1975.

Useful anionic surfactants include the water-soluble salts, particularly the alkali metal, ammonium and alkylolammonium (e.g., monoethanolammonium or triethanolammonium) salts, of organic sulfuric reaction products having in their molecular structure an alkyl group containing from about 10 to about 20 carbon atoms and a sulfonic acid or sulfuric acid ester group. (Included in the term “alkyl” is the alkyl portion of aryl groups.) Examples of this group of synthetic surfactants are the alkyl sulfates, especially those obtained by sulfating the higher alcohols (C₈₋₁₈ carbon atoms) such as those produced by reducing the glycerides of tallow or coconut oil.

Other anionic surfactants herein are the water-soluble salts of: paraffin sulfonates containing from about 8 to about 24 (preferably about 12 to 18) carbon atoms; alkyl glyceryl ether sulfonates, especially those ethers of C₈₋₁₈ alcohols (e.g., those derived from tallow and coconut oil); alkyl phenol ethylene oxide ether sulfates containing from about 1 to about 4 units of ethylene oxide per molecule and from about 8 to about 12 carbon atoms in the alkyl group; and alkyl ethylene oxide ether sulfates containing about 1 to about 4 units of ethylene oxide per molecule and from about 10 to about 20 carbon atoms in the alkyl group.

Other useful anionic surfactants herein include the water-soluble salts of esters of α-sulfonated fatty acids containing from about 6 to 20 carbon atoms in the fatty acid group and from about 1 to 10 carbon atoms in the ester group; water-soluble salts of 2-acyloxy-alkane-1-sulfonic acids containing from about 2 to 9 carbon atoms in the acyl group and from about 9 to about 23 carbon atoms in the alkane moiety; water-soluble salts of olefin sulfonates containing from about 12 to 24 carbon atoms; and β-alkyloxy alkane sulfonates containing from about 1 to 3 carbon atoms in the alkyl group and from about 8 to 20 carbon atoms in the alkane moiety.

Particularly preferred anionic surfactants herein are the alkyl polyethoxylate sulfates of the formula:
RO(C₂H₄O)ₓSO₃⁻M⁺
wherein R is an alkyl chain having from about 10 to about 22 carbon atoms, saturated or unsaturated, and the longest linear portion of the alkyl chain is 15 carbon atoms or less on the average, M is a cation which makes the compound water-soluble, especially an alkali metal, ammonium or substituted ammonium cation, and x is from 1 to about 15. The surfactant component of the present compositions preferably comprises from about 60% to about 100%, by weight of the surfactant component, of an alkyl polyethoxylate sulfate, preferably at least about 70%, more preferably at least about 80%.

Other preferred anionic surfactants are the non-ethoxylated C₁₂₋₁₅ primary and secondary alkyl sulfates. Under cold water washing conditions, i.e., less than about 65° F. (18.3° C.), it is preferred that there be a mixture of such ethoxylated and non-ethoxylated alkyl sulfates.

Mixtures of the alkyl sulfates with the above-described paraffin sulfonates, alkyl glyceryl ether sulfonates and esters of a α-sulfonated fatty acids, are also preferred.

The anionic surfactant component herein may comprise low levels of alkyl benzene sulfonates, but must comprise no more than about 6%, preferably less than about 3%, more preferably less than about 2% of alkyl benzene sulfonates. Most preferably, the detergent compositions herein contain no alkyl benzene sulfonates. These include alkylbenzene sulfonates in which the alkyl group contains from about 9 to about 15 carbon atoms, in straight chain or branched chain configuration, e.g., those of the type described in U.S. Pat. No. 2,220,099 and No. 2,477,383. Especially troublesome are linear straight chain alkylbenzene sulfonates in which the average number of carbon atoms in the alkyl group is from about 11 to about 14.

While not intending to be limited by theory, it is believed that the quaternary ammonium agent (a cationic surfactant) and anionic surfactants typically form ion pair complexes in aqueous solutions. The ion pairs formed between the described cationic surfactants and alkylbenzene sulfonate salts have low solubility and precipitate as a separate solid salt. This not only has a negative effect on their cleaning performance, but also prevents their use in isotropic liquid detergents. On the other hand, ion pairs formed by the described cationic surfactants and alkyl polyethoxylate sulfates are much more soluble in the liquid detergent composition herein. This allows for the formulation of isotropic liquid detergents where the cationic agent provides softening, antistatic and cleaning performance, and the cleaning performance of the alkyl polyethoxylate is not impaired.

In addition to the anionic surfactant component, the laundry detergent compositions of the present invention may further contain an ethoxylated nonionic surfactant. The compositions of the present invention preferably contain up to about 30%, preferably from about 0.01% to about 20%, more preferably from about 0.1% to about 10%, by weight of the composition, of an ethoxylated nonionic surfactant. These materials are described in U.S. Pat. No. 4,285,841, Barrat et al, issued Aug. 25, 1981, incorporated herein by reference. Preferred are the ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15. These surfactants are more fully described in U.S. Pat. No. 4,284,532, Leikhim et al, issued Aug. 18, 1981. Particularly preferred are ethoxylated alcohols having an average of from about 10 to about 15 carbon atoms in the alcohol and an average degree of ethoxylation of from about 6 to about 12 moles of ethylene oxide per mole of alcohol.

The addition of an ethoxylated nonionic surfactant to the detergent compositions of the invention herein is helpful in providing physical stability to the detergent product, i.e., preventing phase splits and precipitation. This is particularly true for compositions containing high levels of quaternary ammonium agent and/or low levels of anionic surfactant. Therefore, a preferred embodiment of the invention herein comprises at least about 0.1% of the nonionic surfactant in the detergent compositions herein.

Quaternary Ammonium Fabric-Softening Agent

The compositions herein also contain a quaternary ammonium fabric-softening agent. In one embodiment, the compositions herein contain from about 0.1 to about 10%, alternatively from about 1% to about 10%, alternatively from about 1% to about 4%, alternatively from about 1.5% to about 3%, by weight of the composition, of a quaternary ammonium fabric-softening agent having the general formula: 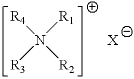
wherein R₁ and R₂ are individually selected from the group consisting of C₁-C₄ alkyl, C₁-C₄ hydroxy alkyl, benzyl, and —(C₂H₄O)ₓH where x has a value from about 2 to about 5; X is an anion; and (1) R₃ and R₄ are each a C₈-C₁₄ alkyl or (2) R₃ is a C₈-C₂₂ alkyl and R₄ is selected from the group consisting of C₁-C₁₀ alkyl, C₁-C₁₀ hydroxy alkyl, benzyl, and —(C₂H₄O)ₓH where x has a value from about 2 to about 5.

In one embodiment, the quaternary ammonium fabric-softening agent is selected from the mono-long chain alkyl quaternary ammonium surfactants wherein in the above formula R₁, R₂, and R₃ are each methyl and R₄ is a C₈-C₁₈ alkyl.

In one embodiment, the quaternary ammonium surfactants are selected from the chloride, bromide and methylsulfate C₈₋₁₆ alkyl trimethyl ammonium salts, and C₈₋₁₆ alkyl di(hydroxyethyl)-methyl ammonium salts. Of the above, lauryl trimethyl ammonium chloride, myristyl trimethyl ammonium chloride and coconut trimethylammonium chloride and methylsulfate are particularly preferred. ADOGEN 412™, a lauryl trimethyl ammonium chloride commercially available from Witco, is a preferred softening agent herein.

In one embodiment, the quaternary ammonium surfactants is selected from the di-C₈-C₁₄ alkyl dimethyl ammonium chloride or methylsulfates; particularly preferred is di-C₁₂-C₁₄ alkyl dimethyl ammonium chloride. This class of materials is particularly suited to providing antistatic benefits to fabrics. Materials having two alkyl chain lengths longer than C₁₄, like di-C₁₆-C₁₈ alkyl dimethyl ammonium chloride, which are commonly used in rinse added fabric softeners, are not included in this invention, since they do not yield isotropic liquid detergents when combined with the anionic surfactants described above.

In one embodiment the quaternary ammonium softening agent contains less than 10 ppm of trimethylamine and/or dimethylamine impurities, more preferably less than 2 ppm. Without being limited by theory, compositions containing greater than 10 ppm of trimethylamine and/or dimethyalmine will have poor odor quality.

A preferred embodiment of the invention herein comprises the detergent composition wherein the weight ratio of anionic surfactant component to quaternary ammonium softening agent is from about 3:1 to about 20:1.

Opacifying Agent

The detergent compositions of the present invention further may comprise an effective amount of an opacifing agent, substantially suspended within the composition. As used herein, the term “opacifing agent” refers to a material which, when added to a formulation having a transmittance of from about 55% to 100% when measured at 440 nm wavelength, is capable of producing a formulation having a transmittance reading of about 20% or less when measured at a 440 nm wavelength. The amount and type of opacifier used will depend on the particular formulation and how much is necessary to produce a formulation with a transmittance of less than about 20%, preferably from about 15% to about 0.1%.

Preferably, the composition comprises from about 0.02% to about 0.5%, by weight of the composition, of the opacifing agent, more preferably from about 0.05% to about 0.4%, more preferably from about 0.1% to about 0.25%.

Preferred opacifying agents for use herein include particles have a mean particle size of from about 50 nanometers to about 300 microns, preferably from about 100 nanometers to about 200 microns, more preferably from about 100 nanometers to about 500 nanometers, more preferably from about 150 nanometers to about 300 nanometers. Preferred opacifying agents are selected from polymer particles, more preferably acrylic or styrene-based polymers, more preferably polyacrylate/polystyrene copolymers.

Transmittance

A standard measurement for opacity is transmittance. To determine the transmittance of a product, a standard industry spectrophotometer reading is taken at 21.1° C. and atmospheric pressure. A GCAS method may be used to determine transmittance; USP 23 method 851 using a cuvette of 10 mm in length.

In a preferred embodiment, the compositions of the present invention have a transmittance before addition of the opacifying agent of from about 55% to about 100% when measured at a wavelength of 440 nanometers and have a transmittance after addition of the opacifving agent of from about 15% to about 0.1%; more preferably from about 4% to about 0.1% when measured at a wavelength of 440 nanometers wavelength.

Turbidity

Another standard measurement for opacity is turbidity. Turbidity measurements are commonly used to determine the quality of drinking water. As used herein, “turbidity” refers to an expression of the optical properties of a sample that causes light rays to be scattered and absorbed rather than transmitted in straight lines through the samples. Turbidity of a liquid composition is caused by the presence of suspended and dissolved matter. Turbidity measurements are expressed as “NTU's,” Nephelometric-Turbidimetric Units. Turbidity may be measured at a temperature of about 21.10 Celsius and at atmospheric pressure by a DRT-100B turbidimeter device that is manufactured and sold by HF Scientific, Inc. according to manufacturer's instructions and calibrated to 0.2 NTU standard.

In a preferred embodiment, the detergent compositions of the present invention have a turbidity before addition of the opacifying agent of from about 5 to about 50 NTUs, more preferably from about 10 to about 20, more preferably about 14 NTUs when measured at atmospheric pressure and 21.1° C. and have a turbidity after addition of the opacifying agent of from about 250 to about 1000 NTUs, more preferably from about 500 to about 950 when measured at a wavelength of 440 nanometers wavelength. Preferred detergent compositions herein have a turbidity of at least 500 NTUs, more preferably from about 600 to about 875 NTUs.

Viscosity

Another standard measurement that may have an effect on opacity is viscosity. For example, viscosity may be measured with a Brookfield LVTDV-11 viscometer apparatus using an RV #2 spindle at 12 rpm.

In a preferred embodiment, the compositions of the present invention have a viscosity before addition of the opacifying agent of from about 100 to about 1000 cps, alternatively from about 100 to about 600 cps, alternatively from about 100 to about 400 cps, alternatively from about 100 to about 300 cps, alternatively from about 200 to 350 cps, alternatively from about 250 to about 400 at 21.1° C. when measured at a atmospheric pressure and 21.1° C. and have a viscosity after addition of the opacifying agent of from about 100 to about 1000 cps, alternatively from about 100 to about 600 cps, alternatively from about 100 to about 400 cps, alternatively from about 100 to about 300 cps, alternatively from about 200 to about 350 cps, alternatively from about, alternatively from about 200 to 350 cps at 21.1° C.

Color

Another standard measurement that may have an effect on opacity is color. Color measurements referenced herein are determined by the use of Hunter method “Lab” numbers for color. The Hunter Method entitled “Reflection Color of Detergent” is used to determine the reflected color of liquids using a Hunter Color Difference Meter which is commercially available. The liquid composition to be tested in placed in a sample holder and the top surface leveled. The sample is then presented to the instrument and the reading teken. The sample color is reported in terms of three values:
L: Lightness—Black to White
a: Red to Green
b: Yellow to Blue
   These three values characterize the color of the sample. The Hunter Color Difference Meter is calibrated according to manufacturer's directions.

The apparatus used are the HungerLab LabScan XE (LSXE) with 2.5″ glass HunterLab sample cups, having 50 mm, 10 mmoptical galss transmission cells and 70 mm diameter, 50 mm deep or equivalent size.

In one embodiment, the liquid compositions of the present invention have an “L” value of from about 10 to about 55; alternatively from about 15 to about 50; and alternatively from about 42 to 50.

In one embodiment, the liquid compositions of the present invention have an “a” value of from about −12 to about zero; alternatively from about −12 to about 2; and alternatively from about −8 to about −2.

In one embodiment, the liquid compositions of the present invention have a “b” value of from about −40 to about zero; alternatively from about −34 to about zero; and alternatively from about −20 to −34.

In one embodiment, the liquid compositions of the present invention have Lab values as follows:
L is from about 42 to 50;
a is from about −8 to about −2; and
b is from about −20 to about −34.

Example Opacifying Agents

Opacifying agents useful herein include insoluble or partially insoluble materials such as polymeric materials, clays, silica, crystallized compounds (such as “EGDS” a crystallized ethylene glycol distearate), metal oxides (such as titanium dioxide, zinc oxide) and mixtures thereof.

In some embodiments, the opacifying agent may be included in the detergent compositions according to the present invention as an emulsion of water and particulate, and further include a preservative, such as sodium benzoate.

Particularly preferred opacifying agents useful herein include water-based styrene/acrylic emulsions having a percent solids of from about 35% to about 50%, by weight of the emulsion wherein the particles have a mean particle size of from about 0.05 microns to about 0.8 microns, preferably from about 0.1 microns to about 0.6 microns, including the Acusol® product line of opacifiers commercially available from Rohm & Hass. The Acusol® opacifiers are water-based styrene/acrylic emulsions that have a pH from about 2 to about 5 and a mean particle size of from about 0.17 to about 0.45 microns.

Preferred opacifying agents include Acusol® OP301, Acusol® OP302P, Acusol® 303P, Acusol®V304, and Acusol® OP305. When the Acusol® opacifiers are included in the detergent compositions of the present invention, the Acusol® opacifiers are preferably added last in the manufacturing cycle (i.e. after the final pH adjustment) by diluting the emulsion product with at least four times its own weight of water before use, then added very slowly to the final mix, maintaining good agitation.

In a more preferred embodiment, the compositions of the present invention comprise from about 0.02% to about 0.5%, by weight of the composition, of a polyacrylate/polystyrene particle having a mean particle size of from about 150 nanometers to about 300 nanometers, most preferably the particle is ACUSOL OP302P, a polymer synthesized from styrene and acrylate comonomers and made through emulsion polymerization.

Aqueous Liquid Carrier

The liquid detergent compositions according to the present invention also contain an aqueous, non-surface active liquid carrier. Generally the amount of the aqueous, non-surface active liquid carrier employed in the compositions herein will be relatively large. Preferably, the compositions of the present invention comprise from about 40% to about 80% of an aqueous liquid carrier.

The most cost effective type of aqueous, non-surface active liquid carrier is, of course, water itself. Accordingly, the aqueous, non-surface active liquid carrier component will generally be mostly, if not completely, comprised of water. While other types of water-miscible liquids, such alkanols, diols, other polyols, ethers, amines, and the like, have been conventionally been added to liquid detergent compositions as co-solvents or stabilizers, for purposes of the present invention, the utilization of such water-miscible liquids should be minimized to hold down composition cost. Accordingly, the aqueous liquid carrier component of the liquid detergent products herein will generally comprise water present in concentrations ranging from about 30% to 70%, more preferably from about 35% to about 50%, by weight of the composition.

Optional Components

The detergent compositions of the present invention can also include any number of additional optional ingredients. These include conventional laundry detergent composition components such as detersive builders, enzymes, enzyme stabilizers (such as propylene glycol, boric acid and/or borax), suds suppressors, soil suspending agents, soil release agents, other fabric care benefit agents, pH adjusting agents, chelating agents, smectite clays, solvents, hydrotropes and phase stabilizers, structuring agents, dye transfer inhibiting agents, optical brighteners, perfumes and coloring agents. The various optional detergent composition ingredients, if present in the compositions herein, should be utilized at concentrations conventionally employed to bring about their desired contribution to the composition or the laundering operation. Frequently, the total amount of such optional detergent composition ingredients can range from about 10% to about 50%, more preferably from about 30% to about 40%, by weight of the composition. A few of the optional ingredients which can be used are described in greater detail as follows:

Fatty Acid

The compositions of the present invention may optionally contain from about 0.01% to about 10%, preferably from about 2% to about 7%, more preferably from about 3% to about 5%, by weight the composition, of a fatty acid containing from about 8 to about 20 carbon atoms. The fatty acid can also contain from about 1 to about 10 ethylene oxide units in the hydrocarbon chain.

Suitable fatty acids are saturated and/or unsaturated and can be obtained from natural sources such a plant or animal esters (e.g., palm kernel oil, palm oil, coconut oil, babassu oil, safflower oil, tall oil, castor oil, tallow and fish oils, grease, and mixtures thereof), or synthetically prepared (e.g., via the oxidation of petroleum or by hydrogenation of carbon monoxide via the Fisher Tropsch process). Examples of suitable saturated fatty acids for use in the compositions of this invention include captic, lauric, myristic, palmitic, stearic, arachidic and behenic acid. Suitable unsaturated fatty acid species include: palmitoleic, oleic, linoleic, linolenic and ricinoleic acid. Examples of preferred fatty acids are saturated C₁₂ fatty acid, saturated C₁₂-C₁₄ fatty acids, and saturated or unsaturated C₁₂ to C₁₈ fatty a and mixtures thereof.

In the detergent compositions herein containing a fatty acid component, the weight ratio of quaternary ammonium softening agent to fatty acid is preferably from about 1:3 to about 3:1, more preferably from about 1:1.5 to about 1.5:1, most preferably about 1:1.

Organic Detergent Builders

The detergent compositions herein may also optionally contain low levels of an organic detergent builder material which serves to counteract the effects of calcium, or other ion, water hardness encountered during laundering/bleaching use of the compositions herein. Detergent builders are described in U.S. Pat. No. 4,321,165, Smith et al, issued Mar. 23, 1982. Examples of such materials include the alkali metal, citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids C₁₀-C₂₂ fatty acids and citric acid. Other examples are organic phosphonate type sequestering agents such as those which have been sold by Monsanto under the Dequest tradename and alkanehydroxy phosphonates. Citrate salts and C₁₂-C₁₈ fatty acid soaps are highly preferred. Preferred builders for use in liquid detergents herein are described in U.S. Pat. No. 4,284,532, Leikhim et al, issued Aug. 18, 1981. A particularly preferred builder is citric acid.

Other suitable organic builders include the higher molecular weight polymers and copolymers known to have builder properties. For example, such materials include appropriate polyacrylic acid, polymaleic acid, and polyacrylic/polymaleic acid copolymers and their salts, such as those sold by BASF under the Sokalan trademark.

If utilized, the composition may comprise up to 30%, preferably from about 1% to about 20%, more preferably from abut 3% to about 10%, by weight of the composition, of the organic builder materials. While all manner of detergent builders known in the art can be used in the detergent compositions of the present invention, the type and level of builder should be selected such that the final composition has an initial pH of from about 7.0 to about 9.0 at a concentration of from about 1% to about 10% by weight in water at 20° C.

Solvents, Hydrotropes and Phase Stabilizers

The detergent compositions herein may also optionally contain low levels of materials which serve as phase stabilizers and/or co-solvents for the liquid compositions herein. Materials of this type include C₁-C₃ lower alkanols such as methanol, ethanol and/or propanol. Lower C₁-C₃ alkanolamines such as mono-, di- and triethanolamines can also be used, by themselves or in combination with the lower alkanols. If utilized, phase stabilizers/co-solvents can comprise from about 0.1% to 5.0% by weight of the compositions herein.

pH Control Agents

The detergent compositions herein may also optionally contain low levels of materials which serve to adjust or maintain the pH of the aqueous detergent compositions herein at optimum levels. The pH of the compositions herein should range from about 7.8 to 8.5, more preferably from about 8.0 to 8.5. Materials such as NaOH can be added to alter composition pH, if necessary. The ph of the compositions herein may be alkaline.

Enzymes

Enzymes can be included in the formulations herein for a wide variety of fabric laundering purposes, including removal of protein-based, carbohydrate-based, or triglyceride-based stains, for example, and/or for fabric restoration. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or combinations thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents, builders and so on. A preferred enzyme combination comprises a cocktail of conventional detersive enzymes like protease, lipase, cutinase and/or cellulase in conjunction with amylase. Detersive enzymes are described in greater detail in U.S. Pat. No. 6,579,839. Particularly preferred compositions herein contain from about 0.05% to about 2% by weight of detersive enzymes.

Enzymes are normally incorporated at levels sufficient to provide up to about 5 mg by weight, more typically about 0.01 mg to about 3 mg, of active enzyme per gram of the composition. Stated otherwise, the compositions herein will typically comprise from about 0.001% to about 5%, preferably 0.01% to 1% by weight of a commercial enzyme preparation. Protease enzymes are usually present in such commercial preparations at levels sufficient to provide from 0.005 to 0.1 Anson units (AU) of activity per gram of composition.

Proteases useful herein include those like subtilisins from Bacillus [e.g. subtilis, lentus, licheniformis, amyloliquefaciens (BPN, BPN′), alcalophilus,] e.g. Esperase®, Alcalase®, Everlase® and Savinase® (Novozymes), BLAP and variants [Henkel]. Further proteases are described in EP130756, WO91/06637, WO95/10591 and WO99/20726.

Amylases (α and/or β) are described in WO 94/02597 and WO 96/23873. Commercial examples are Purafect Ox Am® [Genencor] and Termamyl®, Natalase®, Ban®, Fungamyl® and Duramyl® [all ex Novozymes]. Amylases also include, for example, α-amylases described in British Patent Specification No. 1,296,839 (Novo), RAPIDASE, International Bio-Synthetics, Inc.

The cellulase usable in the present invention include both bacterial or fungal cellulase. Preferably, they will have a pH optimum of between 5 and 9.5. Suitable cellulases are disclosed in U.S. Pat. No. 4,435,307, Barbesgoard et al, issued Mar. 6, 1984. Cellulases useful herein include bacterial or fungal cellulases, e.g. produced by Humicola insolens, particularly DSM 1800, e.g. 50 Kda and ^{˜}43 kD [Carezyme®]. Also suitable cellulases are the EGIII cellulases from Trichoderma longibrachiatum.

Suitable lipases include those produced by Pseudomonas and Chromobacter groups. The LIPOLASE enzyme derived from Humicola lanuginosa and commercially available from Novo (see also EPO 41,947) is a preferred lipase for use herein. Also preferred are e.g., Lipolase Ultra^{R}, Lipoprime^{R} and Lipex^{R} from Novozymes. Also suitable are cutinases [EC 3.1.1.50] and esterases. See also lipases in Japanese Patent Application 53,20487, laid open to public inspection on Feb. 24, 1978. This lipase is available from Areario Pharmaceutical Co. Ltd., Nagoya, Japan, under the trade name Lipase P “Amano,” hereinafter referred to as “Amano-P.” Other commercial lipases include Amano-CES, lipases ex Chromobacter viscosum, e.g. Chromobacter viscosum var. lipolyticum NRRLB 3673, commercially available from Toyo Jozo Co., Tagata, Japan; and further Chromobacter viscosum lipases from U.S. Biochemical Corp., U.S.A. and Diosynth Co., The Netherlands, and lipases ex Pseudomonas gladioli.

Carbohydrases useful herein include e.g. mannanase (for example, those disclosed in U.S. Pat. No. 6,060,299), pectate lyase (for example, those disclosed in PCT Application WO99/27083), cyclomaltodextringlucanotransferase (for example, those disclosed in PCT Application WO96/33267), xyloglucanase (for example, those disclosed in PCT Application WO99/02663).

Bleaching enzymes useful herein with enhancers include e.g. peroxidases, laccases, oxygenases, (e.g. catechol 1,2 dioxygenase, lipoxygenase (for example, those disclosed in PCT Application WO 95/26393), (non-heme) haloperoxidases.

A wide range of enzyme materials and means for their incorporation into synthetic detergent compositions are also disclosed in U.S. Pat. No. 3,553,139, issued Jan. 5, 1971 to McCarty et al. Enzymes are further disclosed in U.S. Pat. No. 4,101,457, Place et al, issued Jul. 18, 1978, and in U.S. Pat. No. 4,507,219, Hughes, issued Mar. 26, 1985. Enzyme materials useful for liquid detergent formulations, and their incorporation into such formulations, are disclosed in U.S. Pat. No. 4,261,868, Hora et al, issued Apr. 14, 1981. Enzymes for use in detergents can be stabilized by various techniques. Enzyme stabilization techniques are disclosed and exemplified in U.S. Pat. No. 3,600,319, issued Aug. 17, 1971 to Gedge, et al, and European Patent Application Publication No. 0 199 405, Application No. 86200586.5, published Oct. 29, 1986, Venegas. Enzyme stabilization systems are also described, for example, in U.S. Pat. No. 3,519,570.

In one embodiment, the liquid compositions of the present invention are substantially free of (i.e. contain no measurable amount of) wild-type protease enzymes.

Enzyme Stabilizer

If an enzyme or enzymes are included in the compositions of the present invention, it is preferred that the composition also contain an enzyme stabilizer. Enzymes can be stabilized using any known stabilizer system like calcium and/or magnesium compounds, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl)serne salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof.

Additional stability can be provided by the presence of various other an-disclosed stabilizers, especially borate species. See Severson, U.S. Pat. No. 4,537,706. Typical detergents, especially liquids, will comprise from about 1 to about 30, preferably from about 2 to about 20, more preferably from about 5 to about 15, and most preferably from about 8 to about 12, millimoles of calcium ion per liter of finished composition. This can vary somewhat, depending on the amount of enzyme present and its response to the calcium or magnesium ions. Any water-soluble calcium or magnesium salt can be used as the source of calcium or magnesium ions, including, but not limited to, calcium chloride, calcium sulfate, calcium malate, calcium maleate, calcium hydroxide, calcium formate, and calcium acetate, and the corresponding magnesium salts. A small amount of calcium ion, generally from about 0.05 to about 0.4 millimoles per liter, is often also present in the composition due to calcium in the enzyme slurry and formula water. In solid detergent compositions the formulation may include a sufficient quantity of a water-soluble calcium ion source to provide such amounts in the laundry liquor. In the alternative, natural water hardness may suffice.

It is to be understood that the foregoing levels of calcium and/or magnesium ions are sufficient to provide enzyme stability. More calcium and/or magnesium ions can be added to the compositions to provide an additional measure of grease removal performance. Accordingly, as a general proposition the compositions herein will typically comprise from about 0.05% to about 2% by weight of a water-soluble source of calcium or magnesium ions, or both. The amount can vary, of course, with the amount and type of enzyme employed in the composition.

In a liquid composition, the degradation by the proteolytic enzyme of second enzymes can be avoided by protease reversible inhibitors [e.g. peptide or protein type, in particular the modified subtilisin inhibitor of family VI and the plasminostrepin; leupeptin, peptide trifluoromethyl ketones, peptide aldehydes.

Other

Other preferred components for use in liquid detergents herein are the neutralizing agents, buffering agents, phase regulants, hydrotropes, polyacids, suds regulants, opacifiers, antioxidants, bactericides, dyes, perfumes, and brighteners described in the U.S. Pat. No. 4,285,841, Barrat et al, issued Aug. 25, 1981, incorporated herein by reference. Preferred neutralizing agents for use herein are organic bases, especially triethanolamine and monoethanol amine, which results in better detergency performance than inorganic bases such as sodium and potassium hydroxides.

Co-Branding

Due to the nature of the single liquid detergent composition containing dual benefits (softening & cleaning), it may be desirable to co-brand the liquid detergent compositions of the present invention with two or more tradenames, at least one recognizable by consumers as a detergent brand and another recognizable by consumers as a fabric softening brand. Examples of such co-branding include “Tide® with Downy®; “Wisk® with Snuggle®”; and the like. Co-branding may include the dual use of standard marketing materials for each of the brands, such as utilizing the colors associated with a laundry detergent brand in conjunction with the colors associated with a fabric softening brand. Similarly, both tradenames could be used or tradedress of each of the brands.

Such co-branding is useful to provide the consumer with the knowledge that the liquid laundry detergent composition will provide both cleaning and fabric softening benefits, similar to that of their previously recognizable cleaning detergent brand and fabric softening brand.

Composition Form, Preparation and Use

The liquid detergent compositions herein are in the form of an aqueous solution or uniform dispersion or suspension of surfactant, opacifing agent and certain optional other ingredients, some of which may normally be in solid form, that have been combined with the normally liquid components of the composition such as the aqueous liquid carrier, and any other normally liquid optional ingredients.

The aqueous liquid detergent compositions herein can be prepared by combining the components thereof in any convenient order and by mixing, e.g., agitating, the resulting component combination to form the phase stable liquid detergent compositions herein. In a preferred process for preparing such compositions, components will be combined in a particular order. In such a preferred preparation process, a liquid matrix is formed containing at least a major proportion, and preferably substantially all, of the liquid components, e.g., the surfactant, the non-surface active liquid carriers and other optional liquid components with the liquid components being thoroughly admixed by imparting shear agitation to this liquid combination. For example, rapid stirring with a mechanical stirrer may usefully be employed.

While shear agitation is maintained, substantially all of the surfactants and the solid form ingredients can be added. Agitation of the mixture is continued, and if necessary, can be increased at this point to form a solution or a uniform dispersion of insoluble solid phase particulates within the liquid phase.

After some or all of the solid-form materials have been added to this agitated mixture, the particles of the preferred enzyme material, e.g., enzyme prills, are incorporated. Thus the enzyme component is preferably added to the aqueous liquid matrix last.

As a variation of the composition preparation procedure hereinbefore described, one or more of the solid components may be added to the agitated mixture as a solution or slurry of particles premixed with a minor portion of one or more of the liquid components.

After addition of all of the composition components, agitation of the mixture is continued for a period of time sufficient to form compositions having the requisite viscosity and phase stability characteristics. Frequently this will involve agitation for a period of from about 30 to 60 minutes.

The compositions of this invention, prepared as hereinbefore described, can be used to form aqueous washing solutions for use in the laundering of fabrics. Generally, an effective amount of such compositions is added to water, preferably in a conventional fabric laundering automatic washing machine, to form such aqueous laundering solutions. The aqueous washing solution so formed is then contacted, preferably under agitation, with the fabrics to be laundered therewith.

An effective amount of the liquid detergent compositions herein added to water to form aqueous laundering solutions can comprise amounts sufficient to form from about 500 to 7,000 ppm of composition in aqueous washing solution. More preferably, from about 1,000 to 3,000 ppm of the detergent compositions herein will be provided in aqueous washing solution.

The liquid detergent compositions herein may be provided in a multiple use bottle or may be provided to consumers in a number of unit dose packages. Unit dose packages useful herein include those known in the art and include those that are water soluble, water insoluble, water permeable, and mixtures thereof.

### EXAMPLES

The following examples illustrate the compositions of the present invention but are not necessarily meant to limit or otherwise define the scope of the invention herein.

### Examples A-D

Compositions according to the present invention are prepared by mixing together the ingredients listed in Table I in the proportions shown.

TABLE I

| | Weight % | | | |
|---|---|---|---|---|
| Component | A | B | C | D |
| Sodium C12-15 alkyl | 18.0 | 18.0 | 18.0 | 18.0 |
| polyethoxylate (2.5) sulfate | | | | |
| Lauryl trimethyl | 3.5 | 3.0 | 5.0 | 2.0 |
| ammonium chloride | | | | |
| C12-13 alkyl | 4.0 | 2.0 | 4.5 | 2.0 |
| polyethoxylate (9) | | | | |
| C12 alkyl glucose amide | 5.0 | — | — | — |
| Citric acid | 3.0 | 2.0 | 3.0 | 5.0 |
| C12-14 alkyl fatty acid | 2.0 | 5.0 | 3.5 | 3.0 |
| Ethanol | 3.7 | 3.7 | 3.7 | 3.7 |
| Propanediol | 5.0 | 8.0 | 7.0 | 8.0 |
| Monoethanolamine | 0.5 | 1.1 | 1.5 | 1.1 |
| Sodium Borate | 1.0 | 1.5 | 1.5 | 1.2 |
| Tetraethylenepentamine | 1.2 | 1.2 | 1.2 | 1.2 |
| ethoxylated (15-18) | | | | |
| Sodium cumene sulfonate | 0.5 | 3.0 | 3.0 | 0.75 |
| Protease enzyme | 0.9 | 0.9 | 0.9 | 0.9 |
| Lipase enzyme | 0.1 | 0.1 | — | 0.1 |
| Cellulase enzyme | — | 0.08 | — | 0.08 |
| Acusol ® OP302P styrene | 0.2 | 0.18 | 0.22 | 0.25 |
| and acrylate comonomer | | | | |
| 40% solids in aqueous | | | | |
| emulsion | | | | |
| Sodium benzoate | 0.0006 | 0.00054 | 0.00066 | 0.00075 |

| | |
|---|---|
| Sodium hydroxide | To pH of 8.0 |
| Water, perfume and minor | balance |
| ingredients | |

The Table I liquid detergent compositions provide effective fabric cleaning performance and softening benefits to textiles when used to form aqueous wash solutions for conventional fabric laundering operations.

### Example E

A composition of the present invention is prepared by mixing together the ingredients listed in Table II in the proportions shown.

TABLE II

| Component | E |
|---|---|
| Sodium C12-15 alkyl polyethoxylate (2.25) | 18.0 |
| sulfate | |
| Lauryl trimethyl ammonium chloride | 5.0 |
| C12-13 alkyl polyethoxylate (9) | 2.0 |
| Citric acid | 3.0 |
| C12-14 alkyl fatty acid | 2.0 |
| Ethanol | 3.7 |
| Propanediol | 8.0 |
| Monoethanolamine | 1.1 |
| Sodium Borate | 1.0 |
| Tetraethylenepentamine ethoxylated (15-18) | 1.2 |
| Sodium cumene sulfonate | 3.0 |
| Protease enzyme | 0.9 |
| Lipase enzyme | 0.1 |
| Cellulase enzyme | 0.08 |
| Acusol ® OP302P styrene and acrylate | 0.2 |
| comonomer 40% solids in aqueous emulsion | |
| Sodium benzoate | 0.0006 |
| Sodium hydroxide | To pH 8.0 |
| Water, perfume and minor ingredients | balance |

The Table II liquid detergent composition provides effective fabric cleaning performance and softening benefits to textiles when used to form aqueous wash solutions for conventional fabric laundering operations.

1. An, aqueous, heavy duty liquid laundry detergent composition comprising:
a) at least 5%, by weight of the composition, of a surfactant component;
b) from about 0.1% to about 10% of a quaternary ammonium fabric-softening agent having the formula 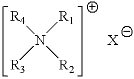
wherein R₁ and R₂ are individually selected from the group consisting of C₁-C₄ alky, C₁-C₄ hydroxy alkyl, benzyl, and —(C₂H₄O)ₓH where x has a value from about 2 to about 5; X is an anion; and (1) R₃ and R₄ are each a C₈-C₁₄ alkyl or (2) R₃ is a C₈-C₂₂ alkyl and R₄ is selected from the group consisting of C₁-C₁₀ alkyl, C₁-C₁₀ hydroxy alkyl, benzyl, and —(C₂H₄O)ₓH where x has a value from about 2 to about 5;
wherein the quaternary ammonium fabric-softening agent comprises less than 10 ppm of trimethylamine and dimethylamine impurities.

2. A detergent composition according to claim 1 wherein the composition has a transmittance of from about 15% to about 0.1% when measured at a wavelength of 440 nanometers wavelength, and has a viscosity of from about 100 to about 600 cps.

3. A detergent composition according to claim 2 wherein the composition has a viscosity from about 200 to about 400 ps

4. A detergent composition according to claim 2 wherein the composition further comprises from about 0.02% to about 0.5% of an opacifing agent.

5. A detergent composition according to claim 2 wherein the composition comprises from about 5% to about 40%, by weight of the composition, of the surfactant component.

6. A detergent composition according to claim 2 wherein said surfactant component comprises;
i) from about 5% to about 40%, by weight of the composition, of alkyl polyethoxylate sulfates wherein the alkyl group contains from about 10 to about 22 carbon atoms and the polyethoxylate chain contains from about 1 to about 15 ethylene oxide moieties; and
ii) no more than about 6% of alkyl benzene sulfonates

7. A detergent composition according to claim 2 wherein the composition has a transmittance of from about 4% to about 0.1%

8. A detergent composition according to claim 1 wherein the composition has a turbidity of from about 250 to about 1000 NTUs.

9. A detergent composition according to claim 4 wherein the opacifying agent has a mean particle size of from about 50 nm to about 300 nm.

10. A detergent composition according to claim 5 wherein the opacifying agent is selected from polymeric materials, clays, silica, crystallized compounds, metal oxides, and mixtures thereof

11. A detergent composition according to claim 2 wherein the quaternary ammonium fabric-softening agent comprises less than 2 ppm of trimethylamine and dimethylamine impurities

12. A detergent composition according to claim 10 wherein the opacifying agent is a polyacrylate/polystyrene copolymer.

13. A detergent composition according to claim 1 wherein the weight ratio of surfactant component to quaternary ammonium fabric-softening agent is from about 2:1 to about 20:1.

14. A detergent composition according to claim 1 wherein the composition is free from precipitates, or more than one liquid or liquid crystalline phase.

15. A detergent composition according to claim 1 wherein the composition comprises from about 10% to about 20%, by weight of the composition, of the surfactant component.

16. A detergent composition according to claim 1 wherein the surfactant component comprises less than about 1%, by weight of the composition, of alkyl benzene sulfonates.

17. A detergent composition according to claim 2 wherein the composition comprises from about 1% to about 10%, by weight of the composition, of the quatemary ammonium fabric-softening agent.

18. A detergent composition according to claim 17 wherein the quatemary ammonium fabric-softening agent is selected from lauryl trimethyl ammonium chloride, myristyl trimethyl ammonium chloride, coconut trimethyl ammonium chloride, coconut trimethyl ammonium methyl sulfate, di-C12-C14 alkyl dimethyl ammonium chloride, and mixtures thereof.

19. A detergent composition according to claim 1 wherein the composition comprises from about 1% to about 5%, by weight of the composition, of lauryl trimethyl ammonium chloride.

20. A detergent composition according to claim 1 wherein the surfactant component comprises an anionic surfactant and further comprises from about 0.01% to about 20%, by weight of the composition, of an ethoxylated nonionic surfactant.

21. A detergent composition according to claim 2 wherein the composition further comprises an enzyme selected from proteases, amylases, lipases, cellulases and mixtures thereof at a level sufficient to provide from about 0.01 mg to about 3 mg of active enzyme per gram of the composition.

22. A hazy, aqueous, isotropic heavy duty liquid laundry detergent composition comprising:
a) from about 5% to about 40%, by weight of the composition, of a surfactant component wherein said surfactant component comprises;
i) from about 5% to about 40%, by weight of the composition, of alkyl polyethoxylate sulfates wherein the alkyl group contains from about 10 to about 22 carbon atoms and the polyethoxylate chain contains from about 1 to about 15 ethylene oxide moieties; and
ii) no more than about 6%, by weight of the composition, of alkyl benzene sulfonates;
b) from about 1% to about 10%, by weight of the composition, of a quatemary ammonium fabric-softening agent having the formula 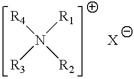
wherein R₁ and R₂ are individually selected from the group consisting of C₁-C₄ alkyl, C₁-C₄ hydroxy alkyl, benzyl, and —(C₂H₄O)ₓH where x has a value from about 2 to about 5; X is an anion; and (1) R₃ and R₄ are each a C₈-C₁₄ alkyl or (2) R₃ is a C₈-C₂₂ alkyl and R₄ is selected from the group consisting of C₁-C₁₀ alkyl, C₁-C₁₀ hydroxy alkyl, benzyl, and —(C₂H₄O)ₓH where x has a value from about 2 to about 5; and
c) from about 0.02% to about 0.5%, by weight of the composition, of an opacifing agent; wherein the composition is free from precipitates, or more than one liquid or liquid crystalline phase; the composition has a transmittance of from about 15% to about 0.1%; and the composition has a turbidity of from about 250 to about 1000 NTUs.
